(19) United States
(12) Patent Application Publication
(10) Pub. No.: US 2018/0164577 A1
(43) Pub. Date: Jun. 14, 2018

(54) ELECTROWETTING DEVICE

(71) Applicant: The University of Manchester, Manchester (GB)

(72) Inventors: Robert Dryfe, Manchester (GB); Anne Juel, Manchester (GB); Deborah Lomax, Manchester (GB); Anna Valota, Manchester (GB)

(21) Appl. No.: 15/579,501

(22) PCT Filed: Jun. 3, 2016
(86) PCT No.: PCT/GB2016/051650

§ 371 Date: Dec. 4, 2017

(30) Foreign Application Priority Data
Jun. 5, 2015 (GB) 1509806.4
Nov. 16, 2015 (GB) 1520170.0

(51) Int. Cl. G02B 26/00; B01L 3/02; B01L 3/00

(52) U.S. Cl. CPC G02B 26/005; B01L 3/022; B01L 3/502792; B01L 2400/0427; B01L 2300/0816; B01L 2400/022; B01L 2400/027; B01L 2300/0645

(57) ABSTRACT

An electrowetting device comprising a cell comprising a working electrode that is formed of a laminar material having a working surface having a surface roughness R_{q} of 20 nm or less. A suitable laminar material is HOPG.

This application claims priority from GB 1509806.4 filed 5 Jun. 2015 and from GB 1520170.0 filed 16 Nov. 2015, each of which is herein incorporated by reference in its entirety.

### FIELD OF THE INVENTION

The present invention relates to devices for and methods of manufacturing devices for manipulating droplets using electrowetting. The invention further relates to the use of certain laminar materials having advantageous surface properties as electrodes in such devices.

### BACKGROUND

On bringing three phases together, it is the interfaces between them that determine the contact angle (CA) at the three phase junction. The three phases are typically a solid, liquid and gas, or a solid and two liquids. The contact angle is used to quantify the wettability of the solid by a liquid. As the drop of liquid on the solid will deform so that the surface tension is minimised, its contact angle θ can be related to the surface energies of the interfaces by Young's equation as the interfacial energies counterbalance at equilibrium.

Electrowetting is the modification of this wetting behaviour with an applied electric field, and was first observed by Lippmann in 1875. Since then, electrowetting has been exploited in a number of areas (Mugele and Baret, 2005).

However, despite the fact that electrowetting shows potential as a powerful method to manipulate solid 1 liquid and liquid 1 liquid interfaces through application of a potential difference, its exploitation has been limited by problems with electrolysis of the electrode. For example, in 1964, Sparnaay et al. measured the contact angle for an electrolyte on a Ge crystal oxidised with an acid-etch, with the oxide essentially forming a dielectric coating (Sparnaay, 1964). A contact angle change was observed for V>|5 V|, a threshold attributed to the potential drop across the oxide surface. However, the work was plagued by many problems that continue to this day, including contamination of the electrode surface and electrolysis which occurs when a certain potential difference level is reached.

In 1992, Sondag-Huethorst and Fokkink investigated the potential-dependent wetting of thiol-modified Au electrodes (Sondag-Huethorst and Fokkink, 1992). Whilst the absolute CA change was low (116° to 110° from −0.35 to +0.8 V vs SCE) the change in surface tension as measured using the Wilhelmy plate method was strong (15-20%). Whilst the expected parabolic surface tension dependence on potential was found, performance was poor with pinning of the contact line.

Importantly, it was observed that the octadecanethiol effectively behaved as a dielectric layer that protected the electrode against electrolysis. This pointed the way towards electrowetting on dielectric (EWOD) research, which is now the most common arrangement used to avoid unwanted electrolysis.

In these systems, a dielectric layer coating is provided on the electrode surface. This serves to block electrolysis. However, very high potentials are required to enact electrowetting—these can exceed 10 or even 100 V (see, for example, Vallet, et al., 1996).

Kakade and co-workers have observed electrowetting on ‘bucky paper’, multi-walled carbon nanotubes treated by ozonolysis—to generate oxygen-containing functional groups—and formed into a film by filtration. The film is provided on a Teflon dielectric layer, which is on top of a Pt electrode. Due to this insulation, the potentials used are ˜5-50 V (Kakade et al., 2008).

More recently, investigations into the use of CVD grown graphene as part of an EWOD device have been reported. The CVD graphene was transferred onto a number of substrates, including Si and Si/SiO₂ wafers, glass slides, and polyethylene terephthalate (PET) films, then coated with a Teflon or Teflon/Parylene C dielectric coating. Electrowetting behaviour was reportedly observed, but once again high potentials were needed, e.g. a 70° C. A change was achieved at 90 V (AC voltage, 1 kHz) (Tan, Zhou and Cheng, 2012). Despite reducing unwanted electrolysis, the high potentials needed limit the usefulness of these electrowetting devices in many applications.

### SUMMARY OF THE INVENTION

The invention is based on the inventors' insight that certain materials may be used to provide an electrode having surface properties permitting low enough potential differences to be used to avoid unwanted electrolysis, while providing excellent variation in contact angle with applied electric field. Furthermore, the surface properties of the electrode may provide excellent reversibility and little or no hysteresis.

As a result of the low applied potential difference needed for satisfactory contact angle variation, the devices of the present invention may be useful in a variety of applications in which low potential differences are desirable. For some applications, only low potential differences are practicable.

Advantageously, the surface properties obviate the need for a dielectric layer, use of which in itself requires high applied potential differences (because of the insulating effect of the dielectric layer). The fact that no dielectric layer is needed increases the ease of manufacture and eventual recycling at the end of the device's life.

As technology moves forward, the demand for good visual displays for devices increases, and in particular, displays which can be comfortably used in a variety of lighting conditions. As devices are increasingly portable, battery life and hence power consumption become of paramount important, while consumers become more discerning and demand high quality, dynamic video display.

Liquid crystals displays (LCD) are the dominant technology. However, they require comparatively high power supplies, hence draining batteries, and they are often difficult to use in strong sunlight. Furthermore, a growing consensus associates the bright nature of LCD screens with sleep problems.

Electrowetting displays offer the potential to provide screens that overcome these problems, and the low voltages permitted by the present invention offer in particular advantages in terms of power consumption. The low hysteresis properties observed are also of importance for dynamism in display and device longevity.

Accordingly, the invention relates to an electrowetting device comprising a cell, the cell comprising a working electrode having a working surface having a surface roughness R_{q} of 40 nm or less, a fluid body provided on the working surface, and a counter electrode, configured such that, when a potential difference is applied between the working electrode and the counter electrode, the fluid body undergoes a potential-induced change in surface tension.

The fluid body is referred to herein as a droplet. This droplet undergoes electrowetting; in other words, the contact angle is changeable during operation of the device, altering the extent of wetting of the working surface. The droplet may be substantially circular in cross section (when viewed from above the working surface), or may be pinned into a corner of the cell to suit the desired use of the device.

The working surface has a roughness R_{q} of 40 nm or less (in other words, R_{q} is 0-40 nm), preferably 35 nm or less, more preferably 30 nm or less, more preferably 25 nm or less, most preferably 20 nm or less.

In a preferred aspect, the working electrode is formed of a laminar material.

Accordingly, in a first aspect the invention may provide an electrowetting device comprising a cell, the cell comprising:
a working electrode that is formed of a laminar material having a working surface having a surface roughness R_{q} of 20 nm or less;
an electrolyte droplet provided on the working surface;
a counter electrode in electronic communication with the droplet;

configured such that, when a potential difference is applied between the working electrode and the counter electrode, the droplet undergoes a potential-induced change in surface tension.

A laminar material refers to a 2D material or bulk 2D material comprising one or more 2D layers, wherein the layers are stacked without covalent bonds between layers. Graphite is an example of a laminar material that is a bulk 2D material, with graphene being the corresponding 2D material. The term “lamellar” is sometimes applied in the art.

In some embodiments, the electrolyte droplet is surrounded by a gaseous phase. For example, the gaseous phase may be air, or an inert gas. In other embodiments, the electrolyte droplet is surrounded by a surrounding liquid phase which is immiscible with the electrolyte droplet. In some embodiments, the surrounding liquid phase, if present, is also an electrolyte. In some embodiments, the surrounding liquid phase, if present, is also not an electrolyte.

It will be appreciated that electrowetting devices of the invention may also be configured such that droplet is not an electrolyte. In this arrangement, the surrounding liquid phase is an electrolyte, and the counter electrode is in electronic communication with the surrounding liquid phase.

Accordingly, in a further aspect, the invention may provide an electrowetting device comprising a cell, the cell comprising:
a working electrode that is formed of a laminar material having a working surface having a surface roughness R_{q} of 20 nm or less, and
a droplet provided on the working surface and a surrounding liquid phase which is an electrolyte, the surrounding liquid phase being immiscible with the droplet;

and a counter electrode in electronic communication with the surrounding liquid phase, configured such that, when a potential difference is applied between the working electrode and the counter electrode, the droplet undergoes a potential-induced change in surface tension.

Suitable electrolytes and liquid phases are discussed herein. In some preferred embodiments, the droplet is an organic droplet and contains, for example, a hydrocarbon (such as an alkane) or an oil, and the surrounding liquid phase is an aqueous electrolyte.

An R_{q} of 20 nm has been found to be especially useful. Higher R_{q} values may be used in some aspects. For example, the roughness may be higher than R_{q} is 20 nm or less, for example, 40 nm or less, 35 nm or less, 30 nm or less, 25 nm or less. For example, R_{q} may be 0-40 nm, 0-35 nm, 0-30 nm, 0-25 nm, 0-20 nm. Some roughness may be unavoidable, and the roughness may for example be 5-40 nm, 5-35 nm, 5-30 nm, 5-25 nm, 5-20 nm.

Preferably, the working surface of the cell is substantially free of major surface defects. These can lead to pinning and loss of electrowetting behaviour. Preferably, the working surface of the cell is substantially free of defects of height greater than 100 nm, optionally greater than 50 nm, optionally greater 20 nm.

It will be appreciated that other suitably smooth surfaces may be used. In a further aspect therefore, the invention may provide an electrowetting device comprising a cell, the cell comprising:
a working electrode having a working surface having a surface roughness R_{q} of 20 nm or less;
an electrolyte droplet provided on the working surface;
a counter electrode in electronic communication with the droplet;

configured such that, when a potential difference is applied between the working electrode and the counter electrode, the droplet undergoes a potential-induced change in surface tension.

Once again, it will be appreciated that it is not essential that the droplet is an electrolyte. A surrounding liquid phase that is an electrolyte can be used. In other words, the droplet may be an electrolyte optionally surrounded by a surrounding liquid phase (which may itself be an electrolyte) or the droplet may not be an electrolyte and may be surrounded by a surrounding liquid phase that is an electrolyte.

Accordingly, the invention may further provide an electrowetting device comprising a cell, the cell comprising:
a working electrode having a working surface having a surface roughness R_{q} of 20 nm or less, and
a droplet provided on the working surface and a surrounding liquid phase which is an electrolyte, the surrounding liquid phase being immiscible with the droplet;

and a counter electrode in electronic communication with the surrounding liquid phase, configured such that, when a potential difference is applied between the working electrode and the counter electrode, the droplet undergoes a potential-induced change in surface tension.

The inventors have found that defects on the working surface adversely affect electrowetting performance. They have observed that it is preferable that the surface is substantially free of defects of height greater than 100 nm, optionally greater than 50 nm, optionally greater 20 nm. Accordingly, the present invention further provides an electrowetting device comprising a cell, the cell comprising a working electrode having a working surface that is substantially free of defects of height greater than 100 nm, optionally greater than 50 nm, optionally greater 20 nm; an electrolyte droplet provided on the working surface; a counter electrode in electronic communication with the droplet; configured such that, when a potential difference is applied between the working electrode and the counter electrode, the droplet undergoes a potential-induced change in surface tension.

Similarly, the invention further provides an electrowetting device comprising a cell, the cell comprising a working electrode that is formed of a laminar material having a working surface that is substantially free of defects of height greater than 100 nm, optionally greater than 50 nm, optionally greater 20 nm; a droplet provided on the working surface and a surrounding liquid phase which is an electrolyte, the surrounding liquid phase being immiscible with the droplet; a counter electrode in electronic communication with the surrounding liquid phase; configured such that, when a potential difference is applied between the working electrode and the counter electrode, the droplet undergoes a potential-induced change in surface tension.

The laminar material of any aspect may be a 2D material such as graphene and MoS₂, which may be monolayer, bilayer etc. up to around 10 layers in thickness, nanoplatelets of these materials having a thickness of less than 100 nm, and so called “bulk” 2D materials such as graphite and “bulk” MoS₂. In some preferred embodiments, the laminar material is graphite (preferably HOPG), graphene or MoS₂. Preferably, the laminar material is HOPG.

Graphite, in particular HOPG, has been found to be an excellent working electrode for electrowetting cells. The present invention further relates to use of a laminar material as a working electrode in an electrowetting device. Accordingly, in a further aspect, the invention may provide use of graphite as an electrode in an electrowetting device, optionally wherein the graphite is HOPG. The invention further provides an electrowetting device comprising a cell, the cell comprising a working electrode formed of graphite, optionally HOPG, a droplet; and a counter electrode; configured such that, when a potential difference is applied between the working electrode and the counter electrode, the droplet undergoes a potential-induced change in surface tension.

The droplet may be an electrolyte, and the counter electrode may be electronic communication with the droplet. The droplet may be surrounded by a gaseous phase or a surrounding liquid phase, which may itself be an electrolyte. The droplet may not be an electrolyte, and a surrounding liquid phase which is an electrolyte, the surrounding liquid phase being immiscible with the droplet, may be provided with the counter electrode in electronic communication with the surrounding liquid phase.

In any of the aspects described herein, the droplet may optionally have a diameter of 10 μm to 1000 μm, optionally a diameter of 100 μm to 300 μm. Of course, larger diameters may also be used.

The electrolyte droplet may be an aqueous salt solution. In some embodiments, the concentration of the aqueous salt solution is greater than 1 M, optionally greater than 3 M. In some cases, the concentration is lower. For example, the concentration may be less than 1 M, for example less than 0.5 M, and in some cases less than 0.1 M. In some cases, very low concentrations may be used. The inventors have observed electrowetting down to 0.1 mM KF in air. Accordingly, in some cases, the concentration is less than 0.05 M, less than 0.01 M, less than 0.001 M, or even less than 0.5 mM.

The electrolyte droplet may be an aqueous chloride salt solution (for example, LiCl, KCl, CsCl, MgCl₂), optionally wherein the chloride salt is lithium chloride or magnesium chloride. These salts may be especially suitable for use as electrolyte droplets with concentrations greater than 1 M, for example greater than 3 M.

The electrolyte droplet may be an aqueous hydroxide salt, for example, potassium hydroxide.

The electrolyte droplet may be an aqueous fluoride salt, for example potassium fluoride. These salts may be especially suitable for use with concentrations less than 1 M, for example less than 0.5 M, and in some cases less than 0.1 M, for example, less than 0.05 M, less than 0.01 M, less than 0.001 M, or even less than 0.5 mM, for example 0.1 mM. the inventors have observed electrowetting at concentrations as low as 1 μM.

In some embodiments, the operation of the device is performed at potential differences of less than 16 VI, optionally less than 13 VI.

In some embodiments, the contact angle variance is greater than 30° over |1 V|. It will be appreciated that contact angle variance is often larger for liquid 1 liquid systems when compared to liquid 1 air systems. Accordingly, the contact angle variance in liquid 1 liquid systems may be greater than 100° over |2 V|, for example, greater than 100° over |1.5 V|.

The present invention provides electrowetting devices that operate at advantageously low voltages. Accordingly, the present invention further provides an electrowetting device for which operation of the device is performed at potential differences of less than |3 V|. The present invention further provides an electrowetting device in which the contact angle variance of a droplet is greater than 30° over |1 V|.

The inventors have found that in the devices of the invention, a dielectric layer is not necessary. Accordingly, the droplet can be provided directly on the working surface; in other words, without an intervening layer. In addition to permitting lower potentials, this avoids the problem of defects in the dielectric layer: it is practically difficult to deposit the materials typically used as dielectrics in a defect-free manner over macroscopic areas (Sedev, 2011); either defects which will allow “leakage” of charge will exist, or there will be surface features in the polymer which will tend to lead to “pinning” of the contact angle. The devices of the present invention suitably do not feature any such dielectric layer, so this problem is avoided.

Although no dielectric layer is needed, the inventors have observed that a think layer of an alkane, for example a C₁₀₋₂₀ alkane such as hexandecane can further reduce any pinning observed without the need to reduce the potential used.

The electrowetting devices of the invention may be electrowetting display devices comprising arrays of droplets and/or cells. These devices may be backlit or transflective (i.e. the device may further comprise a light source) or may be reflective. Droplets and/or surrounding liquids may be opaque. For example, they may be white, black or otherwise coloured so as to obscure the working electrode. Graphene is an especially useful working electrode because it is transparent.

The present invention further provides methods of making such electrowetting devices. For example, the method may be a method of providing a laminar material having a working surface, depositing one or droplets onto the working surface, and providing a counter electrode and means to induce a change in potential difference between the working electrode and the counter electrode. The counter electrode may be in electronic communication with the droplet. A surrounding immiscible liquid phase may be present. The counter electrode may be in electronic communication with the surrounding liquid. The set up will depend on the nature of the droplet and surrounding liquid (if present).

As described herein, suitably the working surface has a surface roughness of 20 nm or less, although up to 40 nm may be envisaged for some devices. Accordingly, the working surface of the working electrode may be freshly deposited (for example, CVD graphene) or cleaved. Laminar materials may be cleaved using sticky tape. In some embodiments, the droplets are deposited within 24 h of working surface deposition or cleavage, for example within 12 h, 6 h, 3 h, 1 h, 30 min, 20 min, or even 10 min. Alternatively or additionally, the device may be manufactured in controlled atmospheric conditions (controlled air and humidity levels) to maintain working surface properties.

The method may comprise forming one or more cells on the electrode, for example, by providing a grid to delimit cells. Each cell may comprise a single droplet.

The following observations are made with respect to the low voltage operation:
The potential operation in the absence of a dielectric layer means that electrowetting can be much more efficient at a given potential, since there is no need for a dielectric layer that can lead to a potential drop.
The invention may use high concentration electrolytes. This permits high capacitance change with potential, according to the Young-Lippmann equation (DI water or low concentration electrolytes are commonly used).
The capacitance of HOPG (as it is a semi-metal) is dominated by space-charge capacitance, which itself is a function of potential. This enhances the capacitance change with potential, which contributes to a stronger electrowetting effect.
The readily cleavable nature of “bulk” laminar materials, in particular HOPG, means that the working surface can be easily obtained free from contamination. The surface is also highly regular with few macroscopic defects, both of which minimize unwanted pinning.
The absence of pinning at defects means less energy is required to move the contact line.

Some arrangements of devices of the invention also offer the ability to target low-defect surfaces (with the micropipette/microinjector setup), and the ability to eject small droplets to use only these low-defect areas, as the large electrode wires reside in the pipette, which itself has a much smaller tip diameter.

It will be appreciated that optional and preferred features described with respect to one or more aspects as described herein apply to all other aspects described herein, except where such combinations are expressly excluded.

### DETAILED DESCRIPTION

### Figures

FIG. 1 shows a schematic figure of an electrowetting experimental setup, where CE and RE represent the counter and reference electrodes, and WE represents the working electrode, i.e. the substrate.

FIG. 2 shows a schematic figure of an experimental configuration used for electrowetting in air. HOPG is shown as the working electrode by way of example only, without limitation.

FIG. 3 Backlit side-view images of an aqueous electrolyte droplet (6 M LiCl) in air of initial footprint diameter d=180 μm at E=E_{pzc}=−0.2 V.

FIG. 4 shows analysis data for electrowetting behaviour of an aqueous electrolyte on HOPG. (a) shows the change in apparent contact angle θ−θ_{eq} with applied potential. (b) shows the percentage change in the footprint diameter of the droplet with applied potential. (c) shows current density as a function of applied potential during an electrowetting experiment.

FIG. 5 shows the reversibility for 6 M LiCl, measured by cycling between −0.2 and +0.7 V. This is an average of 3 experiments, showing the high reversibility and reproducibility of the system.

FIG. 6 shows (a) shows the extended reversibility for a single 6 M LiCl droplet over 450 cycles, measured by cycling between −0.2 and +0.6 V. (b) shows a comparison between apparent contact angle measurements when a step-change in potential is applied from E_{zc}=−0.2 V to E, and when E is increased incrementally, from −0.2 V to +0.7 V (wetting) in steps of 0.1 V, and then decreased incrementally in steps of −0.1 V back to −0.2 V (dewetting). (c) shows the same comparison as in (b), where E is incremented up to +0.8 V. (d) shows a comparison between relative diameter variation of the drop footprints for voltage cycling up to +0.7 V and +0.8 V, respectively. (e) shows measurement of the change in diameter of the footprint of the drop over three cycles, where a step-change in potential E is applied from −0.2 V to +0.7 V and then back to −0.2 V.

FIG. 7 show a schematic of the liquid|liquid configurations using two immiscible phases. HOPG is shown as the working electrode by way of example only, without limitation.

FIG. 8 shows side-on photographs of aqueous electrolyte droplets in hexadecane during electrowetting with the liquid|liquid (aqueous|hexadecane) configuration.

FIG. 9 shows liquid|liquid electrowetting on HOPG within the electrolysis potential window. (a) shows the change in apparent contact angle θ−θ_{eq} with applied potential angle. (b) shows the percentage change in the footprint diameter of the droplet with applied potential. (c) shows the current density as a function of applied potential recorded during the electrowetting experiments.

FIG. 10 shows direct comparison of liquid-air electrowetting with the Young-Lippmann prediction for positive applied potentials (Sedev, 2011). (a) shows cosine of the apparent contact angle for a 6M LiCl electrolyte solution (symbols) as a function of the electrowetting number η=1/γ_{LV}∫_{E}_{_{pzc}}^{E}CEdE where E_{pzc}=−0.2 V. C is the capacitance, where the experimental values are shown in (b), and γ_{LV}=83.3±0.11 mN/m, the surface tension of the electrolyte measured using the pendant drop method. The solid line is the Young-Lippmann prediction, where the maximum of cos θ=1 corresponding to complete spreading. (b) shows experimentally measured capacitance as a function of applied potential. The error bars denote the standard deviation of three data sets.

FIG. 11 shows the change of droplet contact angle and diameter as a function of applied voltage. The potential scale for each curve is shifted (E−E_{pzc}) so the PZC of each lies at 0 V.

FIG. 12 shows the change of droplet contact angle as a function of applied voltage. The modulus of the potential is given, and the scale for each curve is shifted (E−E_{pzc}) so the PZC of each lies at 0 V.

FIG. 13 shows cyclic voltammograms for each of the electrolytes used, in the potential range of the electrowetting experiments.

The following abbreviations are used in this application:

γ surface tension

γ^{eff} effective surface tension

γ_{SV} solid|vapour interfacial energy

γ_{SL} solid|liquid interfacial energy

γ_{LV} liquid|vapour interfacial energy

θ contact angle

C capacitance

E potential

E_{pzc} potential of zero charge

AFM atomic force microscopy

CA contact angle

CE counter electrode

CVD chemical vapour deposition

EW electrowetting

EWOC electrowetting on conductor

EWOD electrowetting on dielectric

HOPG highly ordered pyrolytic graphite

RE reference electrode

rGO reduced graphene oxide

WE working electrode

### Definitions

Electro Wetting Device

The devices of the invention comprise one or more liquid droplets arranged within the device such that application of a potential difference causes the or at least one droplet to undergo a potential-induced change in surface tension.

The device comprises a working electrode, which is the surface on which electrowetting occurs. The device further comprises a counter electrode. In use, a potential difference is applied between the two electrodes. A reference electrode may be provided.

This arrangement forms an electrowetting cell. Optionally, the cell may have a wall or walls delimiting the edges of the cell. Optionally, the cell may be of fixed area (defined with respect to the working electrode surface). Optionally, the cell may be of fixed volume.

Cells may be liquid|air cells (i.e. the or each droplet may be surrounded by a gaseous phase) or liquid|liquid cells (i.e. the or each droplet may be surrounded by a second, immiscible, liquid phase). liquid|liquid cells suitably are delimited by at least one wall to define an enclosed area (and optionally volume).

The electrowetting device may comprise a single cell, or a plurality of cells. For example, a grid structure may be placed on the working surface of an electrode to demit a plurality of cells. Each cell may contain one or more droplets. For example, in some embodiments, each cell corresponds to a pixel on a display device, and an array of cells are provided. Optionally, each cell comprises a single droplet. For example, the cells may be delimited by pixel walls. The droplet may be pinned to a cell wall, for example in a corner.

During use, the contact area of the droplet(s) may be adjustable to such an extent that at certain potentials >70% of the working surface of the cell is obscured. For example, the device may be operable to obscure >75%, >80%, >85%, >90%, >95%, >97% of the working surface of the cell. For some applications, >100% of the working surface may be obscured at certain potentials. It will be appreciated that cell and droplet size may be adjusted accordingly.

Devices may comprise an array of such cells. For example, in some embodiments, the device comprises >10 cells, >50 cells, >100 cells, >500 cells, >1000 cells, or even >10 cells droplets.

Working Electrode

As used herein, the working electrode refers to the electrode on which the electrowetting occurs. It may also be referred to as the substrate.

It will be appreciated that devices of the invention may be provided as cells. Each cell may contain one droplet, or several, or even many droplets. Accordingly, in these embodiments the surface of the working electrode is described with respect to a cell.

The working electrode has a smooth surface on which the droplet is placed. This may be referred to as the working surface or electrowetting surface. Suitably, the working surface of the substrate in the cell has a roughness of R_{q}=20 nm or less. For example, the roughness may be R_{q}=15 nm or less.

Suitably, the working surface has few defects. Defects may impede electrowetting, and may lead to pinning and/or hysteresis. For example, the working surface of the substrate may have few or no step defects having a height >100 nm. Suitably, less than 10% of the defects on the working surface have a height >100 nm, preferably less than 5%, more preferably less than 2%, or even less than 1%. In some embodiments, the working surface is substantially free of defects greater than 100 nm.

These defects are typically “steps”. A step refers to a region of height change on the surface. This might be the vertical join between two horizontal planes with mismatched height, or a trough or mound that intersects a flat region of the electrode surface. Accordingly, suitably the working surface is substantially free of steps having a height greater than 100 nm, optionally greater than 80 nm, greater than 70 nm, greater than 60 nm, greater than 50 nm, greater than 40 nm, greater than 30 nm, or even greater than 20 nm.

Point protrusions may affect performance. A point protrusion is a localised height change above the face of the electrode. These typically have an aspect ratio such that the lateral dimension is equal to or smaller than the feature height. Accordingly, in some embodiments, the working surface is substantially free of point protrusions having a height greater than 50 nm, optionally greater than 40 nm, greater than 30 nm, greater than 20 nm.

The smoothness and defect-levels of the working surface were determined as follows:

AFM images were collected in PeakForce QNM tapping mode with a Multimode8 (Bruker®) using silicon nitride SNL-10 cantilevers. Image analysis was performed with Nanoscope Analysis (v1.6, Bruker®). All images were processed using the 2nd order Flatten procedure before analysis using the Section tool to determine step heights and the Roughness tool to find Rₐ and R_{q}, the mean roughness and root mean square (RMS) roughness respectively,

$${R}_{q} = \sqrt{\frac{\sum {Z}_{i}^{2}}{N}}$$

$${R}_{a} = \frac{1}{N} {\sum }_{i = 1}^{N} \vert {Z}_{i} \vert$$

where, z is the feature height and N is the number of measured features.

As described herein, the working surface is typically provided free of a dielectric layer. In other words, the droplet to undergo electrowetting may be placed directly onto the working surface of the substrate, without an intervening layer.

Suitably, the working electrode is a laminar material. Laminar material, as used herein, refers to a material comprising one or more layers of 2D material. Layers are typically stacked substantially parallel to each other, without covalent bonds between layers. Accordingly, the term includes 2D materials such as graphene and MoS₂, which may be monolayer, bilayer etc. up to around 10 layers in thickness, nanoplatelets of these materials having a thickness of less than 100 nm, and so called “bulk” 2D materials such as graphite and “bulk” MoS₂.

Suitably, the working electrode is graphite (for example highly ordered pyrolytic graphite), graphene (for example, deposited onto a flat surface such as metal film, oxide covered silicon wafer, mica or other suitable surface) or other conductive laminar material. Suitable 2D materials are known in the art. Graphene has the additional advantage of being transparent and flexible. Other 2D materials include, without limitation, transition metal dichalcogenides such as MoS₂, MoSe₂, and WS₂.

In some embodiments, the working electrode of the device is graphite.

HOPG

Highly ordered pyrolytic graphite (HOPG) is a highly-ordered form of high-purity pyrolytic graphite (a typical commercial impurity level is on the order of 10 ppm ash or better).

HOPG is characterized by the highest degree of three-dimensional ordering. HOPG belongs to the class of laminar materials because its crystal structure is characterized by an arrangement of carbon atoms in stacked parallel layers. In bulk HOPG, as in bi- and multi-layer graphene, adjacent layers are preferentially stacked in an ABAB (or Bernal) fashion, where two hexagonal lattices (the A lattice and the B lattice) are off-set from one another. Bernal stacking is energetically preferential, though other configurations such as ABC stacking and turbostratic (disordered) stacking can occur.

HOPG is a polycrystalline material, so exhibits stacking of the layers within grains, but grain boundaries will separate these stacked regions. A measure of HOPG quality is how parallel the stacking is in the separate grains that make up the working electrode surface, termed the mosaic spread angle. The HOPG used in examples described herein was obtained from SPI Supplies®, the SPI-1 grade used here exhibits a mosaic spread of 0.4°+/−0.1°; lateral grain size is typically up to about 3 mm but can be as large as 10 mm.

Owing to this very small spread, HOPG is cleavable to provide very smooth, graphene-like surfaces. The inventors have found that this cleaved HOPG surface has excellent properties as a working surface in electrowetting devices, showing excellent electrowetting behaviour at low potential without the need for a dielectric layer. The surface can be cleaved with adhesive tape using methods known in the art and be readily refreshed as needed.

Accordingly, in preferred embodiments, the working electrode of the device is HOPG.

The inventors have observed, as described herein, unprecedented changes in contact angle using HOPG (over 50 degrees with the application of <1 V). The inventors have found these to be reproducible, stable over 100 s of cycles and free of hysteresis.

Graphene

In some embodiments, the working electrode is graphene or graphitic nanoplatelet structures having a thickness up to 100 nm. The working electrode may be deposited on any suitable surface (for example, a metal film, oxide covered silicon wafer, mica etc.) using techniques known in the art. For example, CVD graphene may be deposited on the surface. Exfoliated material may be deposited, for example using thin film evaporation.

The term “graphene”, as used herein, refers to graphene having up to 10 layers. For example, the graphene may have one, two, three, four, five, six, seven, eight, nine or ten layers.

The graphene and/or graphite nanoplatelet structures used in devices of the present invention may contain one or more functionalised regions. “Functionalised” and “functionalisation” in this context refers to the covalent bonding of an atom to the surface of graphene and/or graphite nanoplatelet structures, such as the bonding of one or more hydrogen atoms (such as in graphane) or one or more oxygen atoms (such as in graphene oxide) or one or more oxygen-containing groups, etc. Suitably, the material used is substantially free of functionalisation, for instance, wherein less than 10% by weight, such as less than 5% by weight, preferably less than 2% by weight, more preferably less than 1% by weight of the working electrode is functionalised. Additionally or alternatively the graphene or graphitic working electrode contains less than 10 at % total non-carbon elements (for example, oxygen and/or hydrogen) based on the total number of atoms in the material, such as less than 5 at %, preferably less than 2 at %, more preferably less than 1 at %.

For instance, it may be preferred that the graphene or graphitic working electrode is substantially free of graphene oxide (i.e. wherein less than 10% by weight, such as less than 5% by weight, preferably less than 2%, more preferably less than 1% by weight of the material produced is graphene oxide).

Transition Metal Dichalcogenides

In some embodiments, the working electrode is a laminar transition metal dichalcogenide. Suitably, the transition metal dichalcogenide is a 2D material, in other words, it is up to 10 layers in thickness.

For example, the transition metal dichalogenide may have one, two, three, four, five, six, seven, eight, nine or ten layers.

The transition metal dichalogenide may be a nanoplatelet material having a thickness of less than 100 nm, or indeed a “bulk” material. The bulk material comprises many 2D layers of material stacked. As described for graphite, the bulk material may be cleaved to reveal a surface having desirable properties.

Counter Electrode

The counter electrode is in electronic communication with the electrolyte. In other words, charge may flow between the electrode and electrolyte. An applied potential difference between the working electrode and the electrolyte causes a change in the surface tension of the droplet.

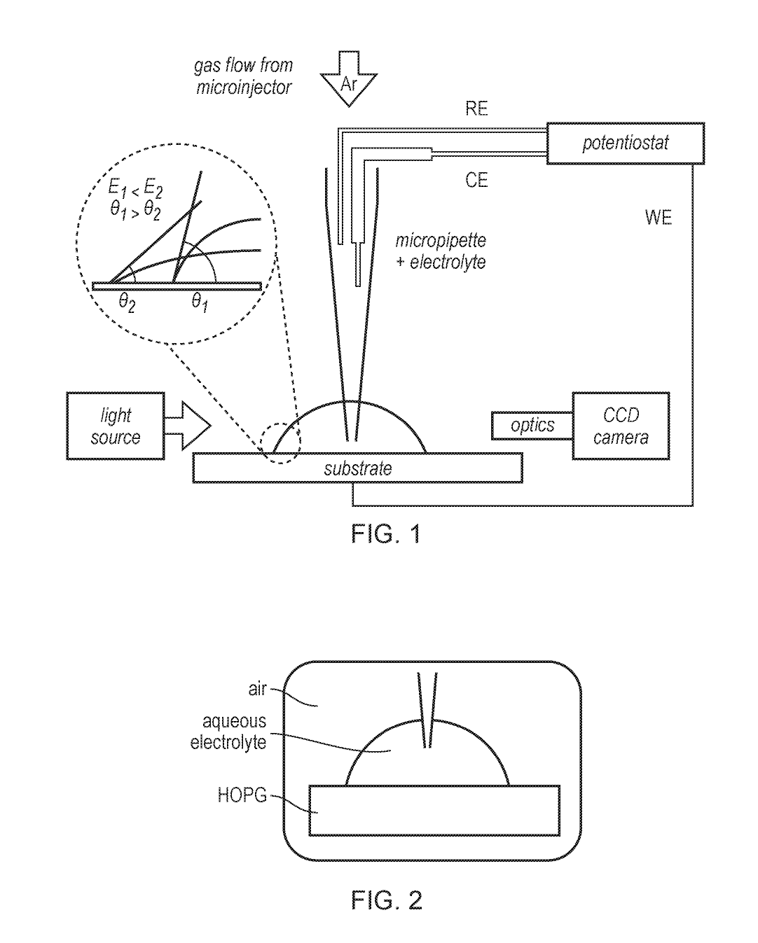

Suitable arrangements for electrowetting devices are known in the art. The following examples are provided without limitation. The counter electrode may be provided in the form of a wire electrode inserted into the droplet and/or a surrounding liquid phase, for example, perpendicular to the working surface of the electrode. In some embodiments, a wire electrode may be contained within a micropipette, the micropipette being inserted into the droplet, as is shown in accompanying FIG. 1. The counter electrode may also be provided on or a part of a cell wall; for example, it may be part of a pixel wall. The counter electrode may also be provided as a plate above the electrowetting surface.

It will therefore be appreciated that where device configuration permits, it is not necessary that each cell in a device having a plurality of cells comprises its own counter electrode, provided the device comprises a counter electrode in electronic communication with an electrolyte. However, in some embodiments, each cell may comprise a counter electrode.

Droplet

A body of fluid is applied to the working surface and during operation of the device the extent to which this body of fluid obscures the working surface of the device varies. For convenience, this is referred to herein as a droplet, although it will be appreciated that the term in context is not limited to a body of fluid having a substantially circular cross section.

It will be appreciated that, for many applications, a plurality of droplets will be used in a single device, for example in an array. Arrays may consist of many 10 s, 100 s, 1000 s or even 10,000 s droplets. For example, arrays of droplets may be used in liquid ink displays. In some embodiments, the device comprises >10 droplets, >50 droplets >100 droplets, >500 droplets, >1000 droplets, or even >10,000 droplets.

The droplet may be provided in air (liquid|air), or surrounded by a further, immiscible liquid (liquid|liquid). Liquid|liquid systems may be preferable for some applications. Suitably, droplets are provided in cells, also referred to electrowetting cells. The or each electrowetting cell may comprise a single droplet or a plurality of droplets.

To suit the application, the droplet may optionally contain a pigment. The droplet may be opaque. For example, the droplet may be white or black (to suit a monochrome or multi-coloured display) or otherwise coloured. For example, it may contain a pigment or pigments. In devices comprising more than one droplet, droplets may be the same or different colours to suit.

The droplet may itself be an electrolyte. Alternatively, the droplet may not be an electrolyte, and instead be surrounded by an immiscible liquid electrolyte. In some embodiments, both droplet and immiscible surrounding phase may be electrolytes.

Suitably, the droplet is an aqueous electrolyte, which may include a mixture of components. This may be surrounded by a gaseous phase, for example, air, or an immiscible liquid phase, for example, an organic phase. This surrounding liquid phase may also contain electrolyte. Suitably, the surrounding liquid phase is free of electrolyte.

Alternatively, the droplet may be an organic droplet surrounded by an aqueous phase. The electrolyte may be present in the droplet, the surrounding phase, or both.

Preferably, the droplet is an aqueous electrolyte. The aqueous electrolyte droplet may be surrounded by an immiscible liquid phase, for example, an organic phase. Any suitable immiscible organic liquid may be used. Suitable surrounding liquid phases include hydrocarbons, for example alkanes such as C₆₋₂₀ alkanes, for example, C₁₀₋₁₈ alkanes, for example, C₁₂₋₁₆ alkanes and other organic compounds. Halogenated hydrocarbons may be used. Oils, for example, silicone oils may be used. Phases which are mixtures of components are also envisaged.

The surrounding liquid phase may be an electrolyte. In other words, it may contain ions. It may be aqueous or organic. Suitable ions for use in organic phases include, but are not limited to, cations such as quaternary ammonium cations, such as tetraalkylammonium, and anions such as BF₄⁻, ClO₄⁻ and PF₆⁻.

Aqueous surrounding phases may be as described herein for the droplet. It will be appreciated that very low concentrations of electrolyte may be used as a surrounding liquid phase, for example less than 0.1 M, less than 0.01 M, less than 1 mM, less than 0.1 mM, less than 0.01 mM. The inventors have demonstrated electrowetting in the liquid|liquid configuration involving an organic electrolyte droplet (20 mM BTPPATPBCI in DCB; bis(triphenylphosphoranylidene)ammonium tetrakis(4-chlorophenyl)borate in 1,2-dichlorobenzene) manipulated by application of potential through the 1 micromolar LiCl surrounding phase.

In some embodiments, the liquid phase surrounding the aqueous droplet is not an electrolyte (it does not contain ions).

The liquid phase surrounding the droplet, if present, may optionally be opaque. For example, if may contain a pigment. For example, the liquid may be white or black (to suit a monochrome or multi-coloured display) or contain a pigment or pigments to produce another colour. In devices comprising more than one cell, each separately containing a surrounding liquid phase, the surrounding liquid phase of each cell may be the same or a different colour to suit. In some preferred arrangements, the surrounding liquid phase is transparent and the droplet is not transparent (for example, it may be white, black or otherwise coloured).

It will be appreciated that the droplet may be organic, and may be surrounded by a gaseous phase or a surrounding liquid phase, for example, an aqueous phase, suitably an aqueous electrolyte phase. Suitable organic compositions are apparent to the skilled person and include mixtures of components. The organic droplet may include alkane, for example, as described above and/or a halogenated hydrocarbon or other organic molecule. The organic droplet may be or include an oil, for example, a silicone oil.

It will also be appreciated that the droplet may be an ionic liquid, and may be surrounded by a gaseous phase or a surrounding liquid phase, for example, an immiscible organic phase. 1-butyl-3-methylimidazolium tetrafluoroborate (BMIM BF₄) and 1-butyl-3-methylimidazolium hexafluorophosphate (BMIM PF₆) are representative ionic liquids. However, lower viscosities may be preferred. The viscosity of BMIM BF₄ at 293.59 K is 109.2 mPa s measured using a rheometer as described in 3. Jacquemin et al., Green Chem., 2006, 8, 172-180, 173, while that of BMIM PF₆ at 293.59 K is 375.9 mPa s using the same method. In some cases, the viscosity of the ionic liquid at 293.59 K using this method may be less than 100 mPa s, for example less than 50 mPa s. It will be appreciated that measurements may vary with temperature and method. For example, the viscosity BMIM BF₄ at 298.15 K is 180 mPa s measured using an oscillating viscometer method as described in M. Galinski et al., Electrochimica Acta 51, 2006, 5567-5580. In some cases, the viscosity of the ionic liquid at 298.15 K using this method may be less than 150 mPa s, for example less than 100 mPa s, for example less than 50 mPa s.

The aqueous electrolyte may be a salt solution in water, for example, an alkali halide or alkali earth halide. Suitable examples are chlorides, for example, LiCl and MgCl₂, and fluorides, for example, KF.

In some embodiments, ions may be provided in a concentration greater than 1 M, preferably greater than 2 M, more preferably greater than 3 M, more preferably greater than 4 M, more preferably greater than 5 M. For example, the concentration of anion may be about 6 M. Of course, lower concentrations may be used as described herein, for example down to 0.1 mM.

For example, the electrolyte may be 6 M LiCl or 3 M MgCl₂. In some embodiments, the electrolyte is 6 M LiCl. In some embodiments, the electrolyte is 3 M MgCl₂. In some embodiments, the electrolyte may be a potassium salt, for example KF or KOH; the concentration may, optionally, be less than 1 M, for example, less than 0.5 M, in some cases less than 0.1 M. In some cases, very low concentrations may be used, for example, the concentration may be less than 0.05 M, less than 0.01 M, less than 0.001 M, or even less than 0.5 mM.

The aqueous electrolyte may be a hydroxide salt, for example KOH.

It should be noted that an electrolyte may be selected to provide electrowetting at both negative and positive potentials. For example, the inventors have demonstrated that aqueous salts shows both cation and anion induced electrowetting behaviour. KF has been shown to demonstrate the most symmetry.

The diameter of the droplet may be selected to suit the desired application of the device. Suitable sizes for use in display devices are known in the art. For example, and without limitation, the diameter may be 5 mm or less, 4 mm or less, 3 mm or less, 2 mm or less, for example, 1 mm or less.

In some embodiments, the droplet diameter may be 10 μm to 1000 μm. Suitably the droplet diameter is 20 μm or larger, for example 30 μm or larger, for example 50 μm or larger, for example 75 μm or larger, for example 100 μm or larger, for example 125 μm or larger, for example 150 μm or larger.

Suitably, the droplet diameter is 1000 μm or smaller, for example 750 μm or smaller, for example 500 μm or smaller, for example 400 μm or smaller, for example 350 μm or smaller, for example 300 μm or smaller.

For example, the droplet diameter may be 10 μm to 500 μm, for example 10 μm to 400 μm, for example 20 μm to 400 μm, for example 30 μm to 400 μm, for example 50 μm to 400 μm, for example 100 μm to 400 μm, for example 100 μm to 300 μm. In the examples and experiments described herein, 60-250 μm diameter droplets were used.

Of course, the term droplet refers to both unpinned droplets, of substantially circular cross section, and fluid bodies of other shapes, for example, pinned at the wall of a cell. In this context, the term diameter will be understood to refer to the greatest dimension taken in the plane parallel to the working surface.

Suitable volumes for use are also apparent to the skilled person. For example, and without limitation, the volume of the droplet may be 100 mm³ or less, 75 mm³ or less, 50 mm³ or less, 25 mm³ or less, 10 mm³ or less, 5 mm³ or less, 3 mm³ or less, 1 mm³ or less, 0.5 mm³ or less, 0.25 mm³ or less, 0.1 mm³ or less, 0.075 mm³ or less, 0.05 mm³ or less, 0.025 mm³ or less, 0.001 mm³ or less. Suitably, the droplet volume may be greater than 500 μm³, for example, greater than 1000 μm³, greater than 5000 μm³, greater than 10000 μm³.

### Examples

The invention will now be demonstrated and illustrated, without limitation, by the following examples.

General Methodology—Liquid|Air

In each of the examples described below, the surfaces on which electrowetting was measured had a surface roughness of not more than around R_{q}=10 nm and were substantially free of ripples and steps.

By way of comparison, electrowetting behaviour was poor, with significant pinning, hindered movement of the contact line and loss of droplet shape integrity on surfaces having significantly higher R_{q} values. The inventors determined that an R_{q} of 20 nm or less is important for good electrowetting behaviour. Similarly, defect height above 100 nm was found to reduce electrowetting performance.

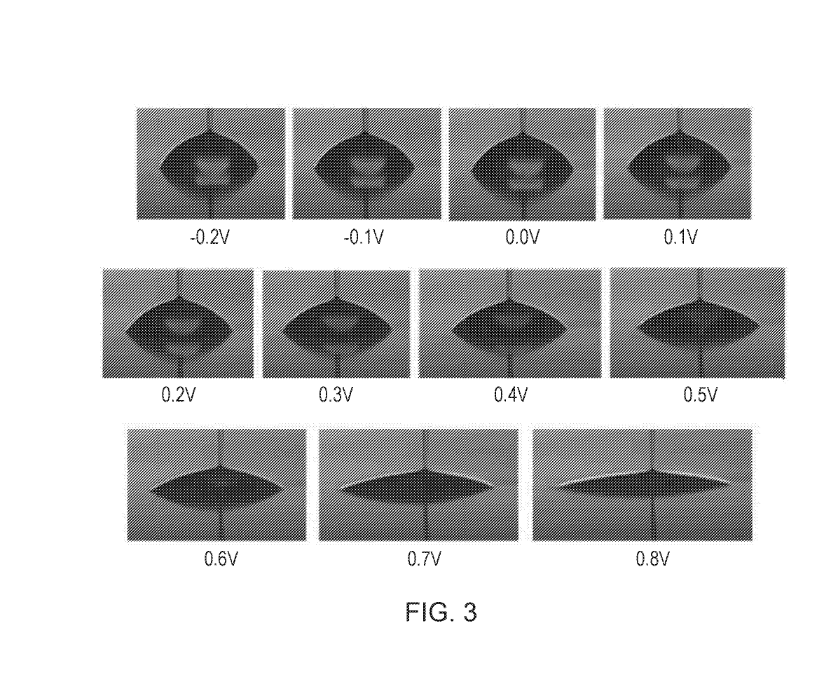

FIG. 1 shows a schematic representation of a liquid|air system electrowetting experiment as described herein. FIG. 2 shows a schematic representation of the droplet during the experiment on an HOPG surface.

A microinjector (PV820 Pneumatic PicoPump) coupled with a micropipette (drawn from borosilicate capillaries with a Sutter P-97 Flaming/Brown Micropipette Puller) was used to place the droplet. As described herein, the pipette also serves as the electrolyte reservoir with the Pt counter and reference electrodes within. As the micropipette contains electrolyte, current may pass, but as the micropipette diameter is much smaller than that of a counter electrode wire (as is used in the prior art methods described herein), the shape of the drop is not significantly disturbed.

This allows the use of small droplets which, along with the fine manipulation of the micropipette position, means that defect-free regions of the substrate can be targeted if desired.

The drops are placed directly onto the electrode surface (without a dielectric).

The potential difference of the system was varied with an Autolab PGSTAT302N potentiostat (Ecochemie, Netherlands) by increments as described, and the behaviour of the droplets observed using a CCD camera (Infinity, Lumenera) with the droplet backlit using an LED light source perpendicular to the droplet.

The droplet shape was determined from such CCD camera obtained images. Images were processed with MATLAB to first perform background subtraction and then to find the droplet edge using the in-built Canny edge detection algorithm. Assuming a spherical shape (i.e. the drops are not influenced by gravity which is likely given their small size and capillary length) the CAs were extracted from the arcs representing the droplet edge near the contact line, implemented by fitting a 4th order polynomial to the Canny-determined edge. Calculation of 0 then followed from the derivative of the polynomial at z=0 where z is the distance from the surface, i.e. from the gradient at the surface:

$$θ = arctan ( \frac{dz}{dx} )$$

The CA relates to the surface tensions of the interfaces by Young's equation:

γ_{SV}−γ_{SL}=γ_{LV} cos θ

The CA is normally related to the applied potential using the Young-Lippmann equation:

$$cos θ ( E ) = cos θ + \frac{{C ( E - {E}_{pzc} )}^{2}}{2 {γ}_{LV}} where$$

$$C = \frac{{ɛ}_{0} ɛ}{d} .$$

cos θ−cos θ_{eq} is often called the electrowetting number.

Liquid|Air on HOPG

Before the placement of each droplet, the surface was cleaved with Scotch tape to create a renewed surface free of contaminants. The effect of airborne contaminants has recently been shown to dramatically impact the contact angle on graphene and HOPG, with clean surfaces showing much more hydrophilic behaviour that previously reported (Li et al., 2013).

Two aqueous electrolytes were used and compared: 6 M LiCl and 3 M MgCl₂. Using the experimental set up shown in FIG. 1. A glass micropipette is placed above the basal plane of a graphite substrate, with an inert gas used to force a droplet of aqueous electrolyte into contact with the graphite. The contact angle of the droplet with respect to the graphite is measured, using a video camera in the plane of the graphite, as a function of the potential applied using a three electrode configuration. In this case, the graphite acts as the working electrode (WE) and the wires serving as counter and reference electrodes (CE, RE, respectively) are placed within the pipette. A concentrated electrolyte solution (6 M LiCl) was generally used, as droplets of this solution were found to be stable with respect to evaporation, and because more pronounced electrowetting was seen at such high electrolyte concentrations (see below). Images of 6 M LiCl droplets during in electrowetting in air (showing the droplet profile and its reflection on the HOPG substrate, FIG. 3) demonstrate the equilibrium contact angle (at E=E_{pzc}=−0.2V) and the dramatic decreases of contact angle when the applied potential is raised to E=+0.4 V, +0.6 V, and +0.8 V.

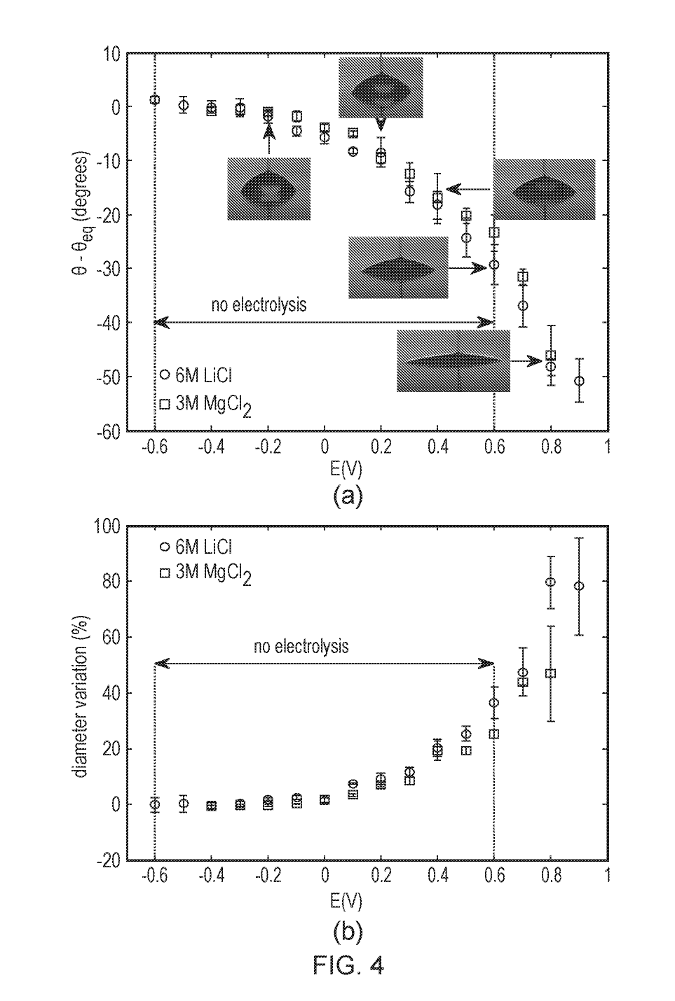

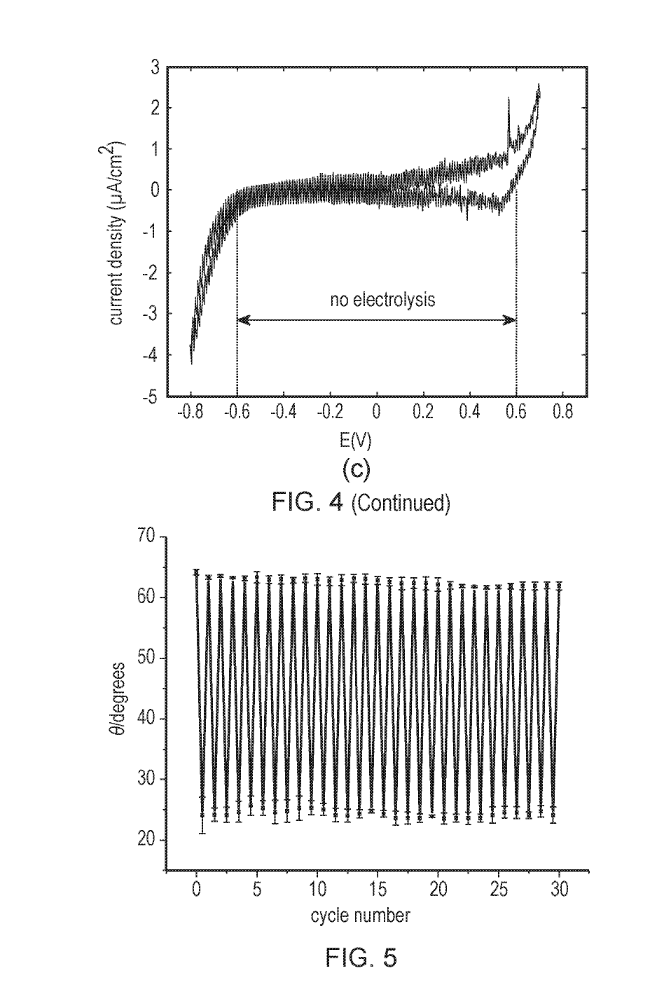

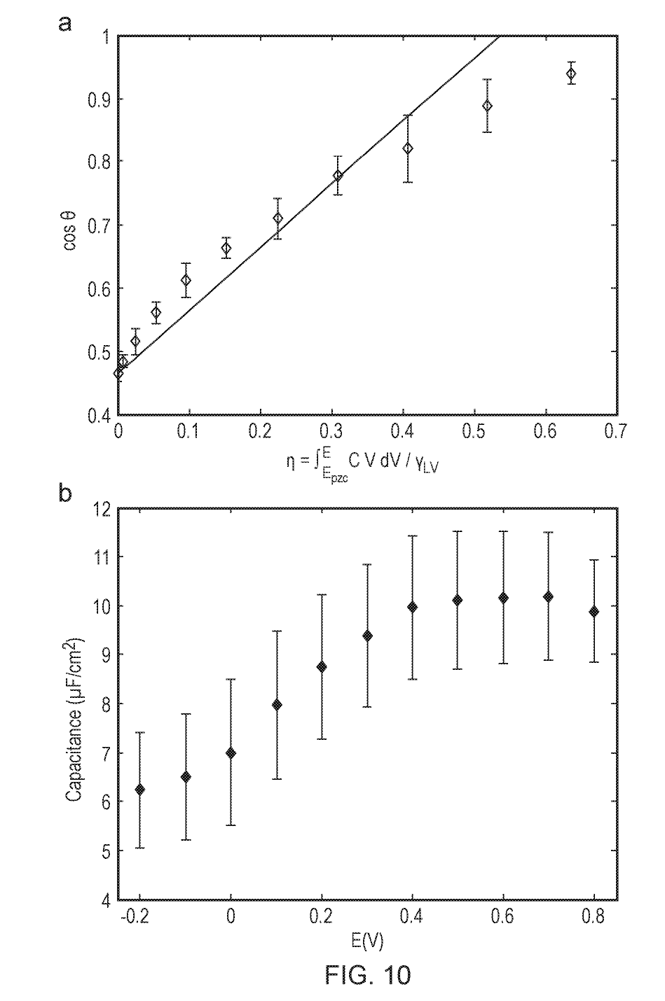

Data obtained on HOPG are presented in FIG. 4 and Table 1. FIG. 4(a) shows the change in apparent contact angle θ−θ_{eq} with applied potential. Significant changes in contact angle of around 50° were observed for both 6 M LiCl and 3 M MgCl₂ over less than 1 V potential range. The values shown are averages of between 5 and 23 experiments, and the error bars correspond to the associated standard deviations. The experiments were performed on freshly deposited droplets, with footprint diameters in the range 60 μm<d<250 μm by applying a step change in potential from E_{pzc}=−0.2 V to the values shown in the graph. The variability in apparent contact angle increases with applied potential, but the apparent contact angle does not saturate within the range of applied potentials (see FIG. 10 for a comparison with the Young-Lippmann prediction). Similar results were obtained for two electrolyte solutions, 6M LiCl and 3M MgCl₂, which both contain equal concentrations of chloride ions. Percentage change in the footprint diameter of the droplet with applied potential was determined (FIG. 4(b)). The rescaled diameter variation collapses onto a single curve despite the fourfold variation in initial diameter. Current density as a function of applied potential during an electrowetting experiment where the applied potential was varied with consecutive small increments/decrements within the range −0.8 V<E<+0.8 V was measured (FIG. 4(c)). The sharp increase in current density for E>+0.6 V and E<−0.6 V, indicates the onset of electrolysis, whereas electrolysis was not present for −0.6 V<E<+0.6 V.

Despite the surface being freshly cleaved and therefore possessing randomly distributed defects each time, there is very little spread in the data, only increasing with strong wetting induced at higher potentials.

TABLE 1

| Electrolyte droplet | θ at −0.2 V | θ at +0.8 V |
|---|---|---|
| 6M LiCl | 62.4° | 20.0° |
| 3M MgCl₂ | 62.9° | 17.4° |

As the data show, different electrolytes give consistent behaviour, with the same contact angles achieved with the same Cl⁻ concentrations from different salts (6 M LiCl and 3 M MgCl₂).

The inventors have further shown that other aqueous electrolytes including KOH and KCl solutions exhibit electrowetting behaviour in the devices and methods of the invention.

No Electrolysis

Importantly, the inventors have observed that the low voltages needed mean that electrowetting can occur in a voltage window which does not cause electrolysis.

It is clear from FIG. 4 that a large change in contact angle is obtained, despite the restricted range of potentials employed experimentally. The potentials applied are therefore large enough to induce electrowetting but small enough to avoid electrolysis (see FIG. 4(c), where the current response normalised to droplet area at each potential is presented). The insensitivity of the wetting effect to potentials lower than E_{pzc}, where cations will accumulate in the solution phase adjacent to the electrode, is not unique to the lithium cation, as a similar effect is found with MgCl₂ solutions (FIG. 4(a)). Taken together, the data of FIG. 4 reveal another key property of graphite surfaces that is essential to their function in EWOC, namely the low electrochemical activity of the graphite basal plane, particularly for electrolytic processes requiring a catalytic function. Metallic surfaces are much more susceptible to the formation of surface oxides and/or electrocatalytic processes associated with water decomposition, which reduces the zone of stability of metal/solution interfaces with respect to electrolysis, and explains why prior attempts at EWOC using metal electrodes were abandoned. In contrast, electrowetting on graphite can occur with minimal electrolytic change in the surface composition and minimal decomposition of the electrolyte.

Reproducibility, Hysteresis and Dynamism

The inventors have further demonstrated that the devices and methods of the invention show excellent reversibility and reproducibility of contact angle. For example, FIG. 5 shows the reversibility of the device using 6 M LiCl measured between −0.2 V and +0.7 V. As FIG. 5 shows, this system is capable of supporting strong electrowetting with no degradation in performance over time. Even over such large 40° transitions, the contact angle at each potential remains constant. The potential was cycled between −0.2 and +0.7 V (0.25 s hold). Each point is an average of 3 experiments on freshly cleaved HOPG, showing the reproducibility of the system.

Contact angle hysteresis commonly occurs in electrowetting as conventionally performed with a dielectric. Hysteresis causes the contact angle for a given voltage to depend on the previous state of the system.

However, as demonstrated herein, remarkably little hysteresis (<1°) is present in the devices and methods of the invention. The wetting and dewetting contact angles closely overlap one another. That the contact angles closely match those found in the static experiments confirms the lack of hysteresis in these devices and methods.

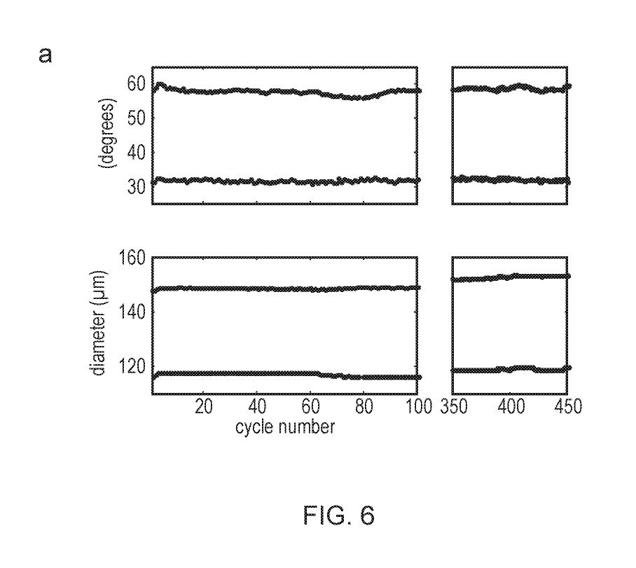

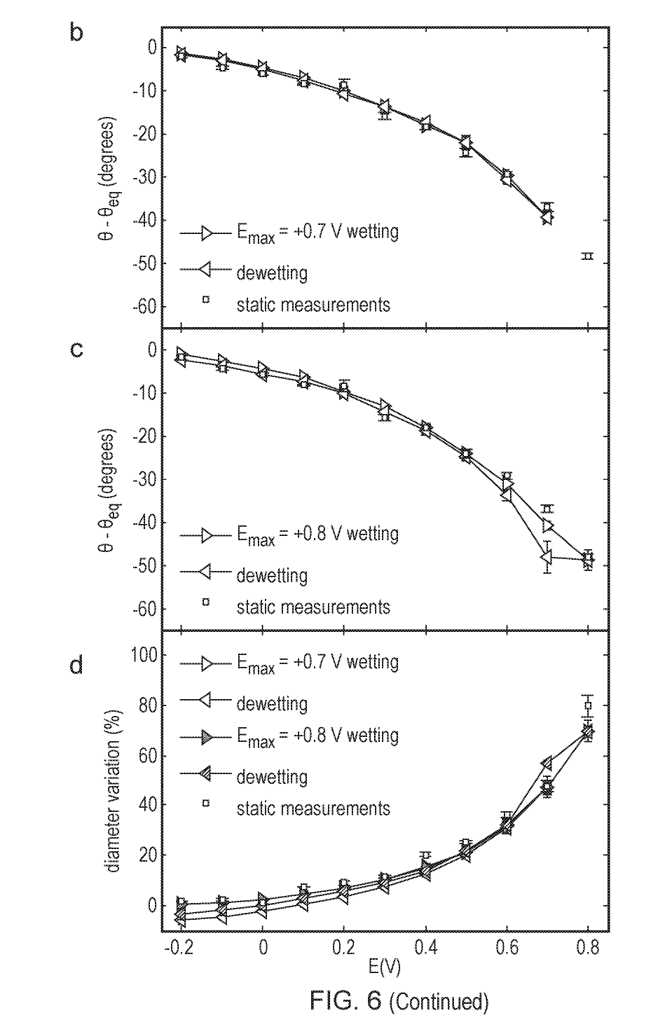

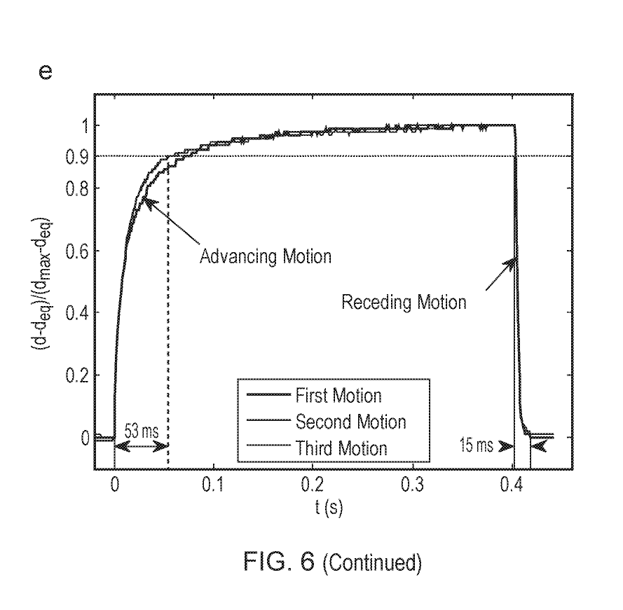

The apparent contact angle of a droplet of 6 M LiCl aqueous solution as a function of cycle number on HOPG was investigated (FIG. 6(a)). In each cycle, a step-change in potential E was applied from −0.2 V to +0.6 V and then back to −0.2 V. Each value of potential was held constant for 0.25 s. The apparent contact angle (diameter) remained constant to within 1.4% (0%) over 100 cycles, and to within 3.9% (3.0%) over 450 cycles, demonstrating the excellent long term reproducibility of the electrowetting process. This was compared to the apparent contact angle measurements when a step-change in potential is applied from E_{zc}=−0.2 V to E, and when E was increased incrementally, from −0.2 V to +0.7 V (wetting) in steps of 0.1 V, and then decreased incrementally in steps of −0.1 V back to −0.2 V (dewetting) (FIG. 6(b)) and where E was incremented up to +0.8 V (FIG. 6(c)). The relative diameter variation of the drop footprints for voltage cycling up to +0.7 V and +0.8 V, respectively, were compared (FIG. 6(e)). Each point corresponds to the average of 3 experiments, and the error bars denote the standard deviation. Even after significant spreading at +0.8 V, where electrolysis currents can be detected, the differences in diameters and contact angles between wetting and dewetting experiments were very small, and there is excellent agreement with the static measurements. The change in diameter of the footprint of the drop over three cycles was also measured (FIG. 6(e)). A step-change in potential E was applied from −0.2 V to +0.7 V and then back to −0.2 V. The initial diameter of the drop was d_{eq}=210 μm, and the maximum diameter was dₘₐₓ=319 μm. The graph indicates excellent dynamic reproducibility, with wetting motion slower than dewetting motion. The switching times to reach a change in diameter of 90% were 53 ms for the spreading droplet, and 15 ms for the receding droplet.

For Eₘₐₓ=+0.8 V, some pinning was shown by the larger diameter of the dewetting droplets after +0.8 V, reflected in the slight (˜7°) hysteresis present after this strong wetting. However, the overlapping behaviour is recovered for the dewetting droplets at lower (<+0.5 V), showing the robustness of the system.

The dynamics of the electrowetting process is an area that is largely unresolved in the extant literature. The rapid (order of 10 ms) response of an EWOC process according to the present invention is shown in FIG. 6(e), where the asymmetric nature of the advancing and receding motion of the droplet is illustrated on HOPG. Furthermore there is only a slight difference between the initial advances and subsequent cycles. The rapid, reproducible dynamics of EWOC again most likely reflect a further advantageous feature of the graphite surface, namely the smoothness of the substrate, which possesses macroscopic (mm scale) lateral domains disrupted only by microscopic (sub-micron scale) steps, facilitating the lateral motion of the droplet.

Liquid|Liquid on HOPG

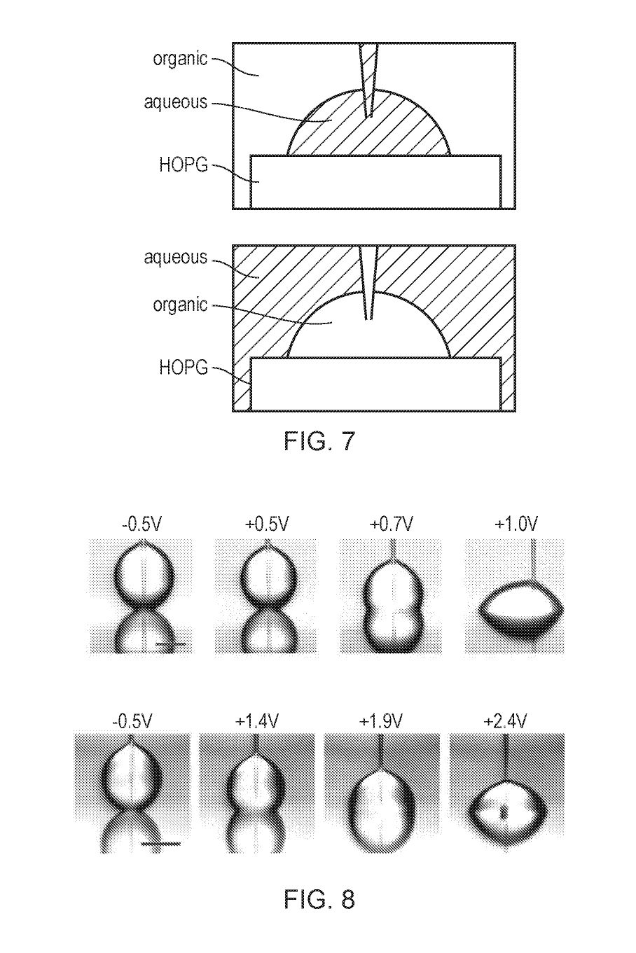

The devices and methods of the invention also relate to liquid|liquid configurations. liquid|liquid configurations include at least two immiscible liquid phases. Possible configurations of two phase liquid|liquid systems are shown in FIG. 7. These are an aqueous droplet within an organic phase, and an organic droplet within an aqueous phase.

liquid|liquid configurations may be desirable for some applications because the total volume of the “cell” remains constant during electrowetting.

FIG. 8 shows side-on photographs of a 6 M LiCl|hexadecane system (a droplet of aqueous LiCl in an organic phase). The system and experiment were otherwise as described above.

The droplets were of initial footprint diameter d=51 μm (first row) and d=77 μm (second row) at E=E_{pzc}=−0.5 V. The apparent contact angle decreases with both positive applied potentials (E=+0.5 V, +0.7V, +1.0 V; first row) and negative applied potentials (E=−1.4 V, −1.9 V, −2.4 V; second row).

As can be seen from FIG. 8, the initial contact angle of the droplet was much higher than in air, reflecting the addition of the more strongly wetting organic phase. On increasing the potential, a contact angle change was observed at +1.0 V. The potentials involved are slightly higher (a factor of 2 or 3) than comparable experiments in air. On placing a small amount of hexadecane on HOPG, the organic phase completely wets the surface as opposed to forming a droplet. It is possible that an organic film forms between the HOPG and the droplet, which acts as transient dielectric layer (as opposed to permanent dielectric layer) and therefore raises the potentials needed to observe a contact angle change.

Note the small gas bubble present within the drop for the largest negative potential E=−2.4 V, which is associated with electrolysis.

This transient dielectric layer differs significantly from a permanent dielectric layer, as is commonly used in devices. Accordingly, the behaviour remains “dielectric free”, as described below.

The difference between the “dielectric free” electrowetting of the invention and the EWOD behaviour can be observed in terms of the capacitance, which is dependent on the depth of the dielectric layer for EWOD, and the film thickness for an adsorbed solvent layer (“transient dielectric”), as discussed in Mugele et al (Mugele and Baret, 2005).

The Young-Lippman equation for a droplet directly on an electrode is:

$$cos θ ( E ) = cos θ + \frac{{C ( E - {E}_{pzc} )}^{2}}{2 {γ}_{LV}}$$

The capacitance C depends on the dielectric constant of the liquid ε and the thickness of the Helmholtz layer dH (a few nanomaters):

$$C = \frac{{ɛ}_{0} ɛ}{{d}_{H}}$$

Modified for EWOD, capacitance depends on the dielectric constant and thickness of the dielectric instead:

$$C = \frac{{ɛ}_{0} {ɛ}_{d}}{d}$$

Also, capacitance is incorporated into the electrowetting number η (Mugele and Baret, 2005):

$$η = \frac{{ɛ}_{0} {ɛ ( E - {E}_{pzc} )}^{2}}{2 {d}_{H} {γ}_{LV}} = \frac{{C ( E - {E}_{pzc} )}^{2}}{2 {γ}_{LV}}$$

The dimensionless electrowetting number “measures the strength of the electrostatic energy compared to surface tension” (Mugele and Baret, 2005).

In the case of EWOD experiments, the dielectric thickness (10-100 s of microns) is very large compared to the size of the Helmholtz layer (nanometers) that determines capacitance on bare electrodes. The small capacitance induced by the size of the dielectric layer results in the high potentials required in EWOD setups to change the CA.

In terms of q, for EWOD this is “typically four to six orders of magnitude smaller [ . . . ] depending on the properties of the insulating layer.” (Mugele and Baret, 2005)

Estimated for the case without a dielectric layer and water:

C=8.854×10⁻¹² F/m×81/5×10⁻⁹ m=0.14 F m⁻²

For a 70 μm PET dielectric as used in [Vallet1996]:

C=8.854×10⁻¹² F/m×2/70×10⁻⁶ m=2.5×10⁻⁷ F m⁻²

which demonstrates the several orders of magnitude difference in capacitance, in line with the difference in R.

To achieve the same low capacitance as the dielectric layer, the adsorbed organic layer would have to be of the same thickness (the dielectric constants are comparable). However, the potentials used to achieve a CA change are much lower, closer to the aqueous|air case than the dielectric case in (Vallet, 1996), hence it follows the capacitance and electrowetting number are closer to the aqueous|air case.

Unlike the liquid|air case, there appears to be contact angle saturation: there was no further electrowetting above +1.4 V despite the droplet possessing a finite contact angle rather than demonstrating complete wetting. Furthermore, electrowetting at negative potentials was demonstrated, which was not apparent with the same aqueous phase in air. This could be useful for performing electrowetting within the potential window with no electrolysis. For example, for an electrolyte/electrode combinations where an oxidative process occurs at positive potentials, a negative potential to induce electrowetting may be more appropriate if no reduction side-reactions occur.

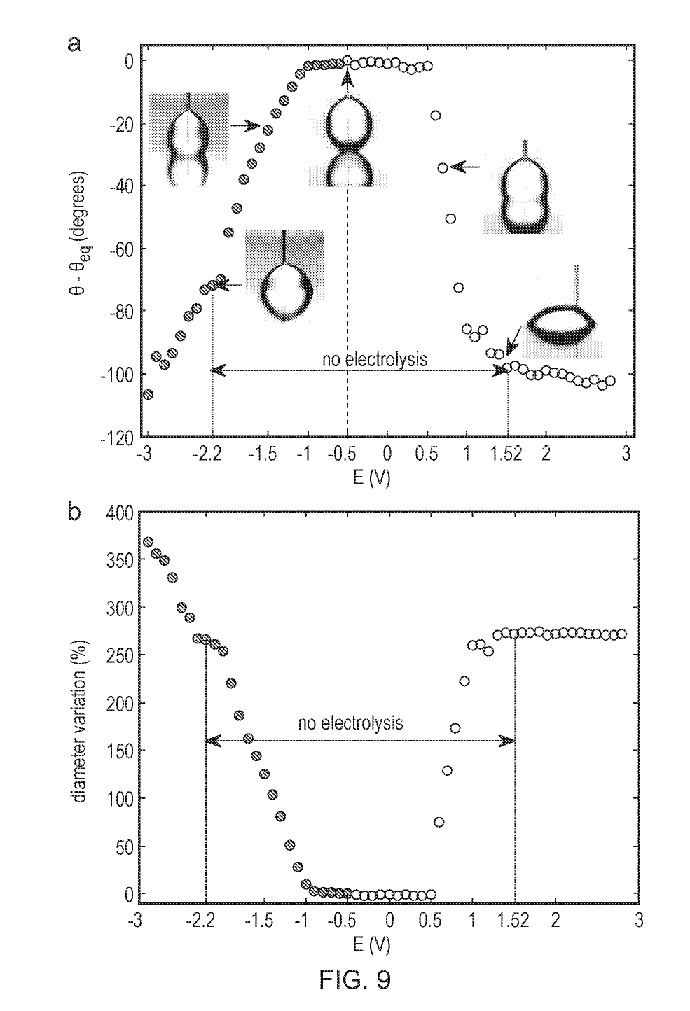

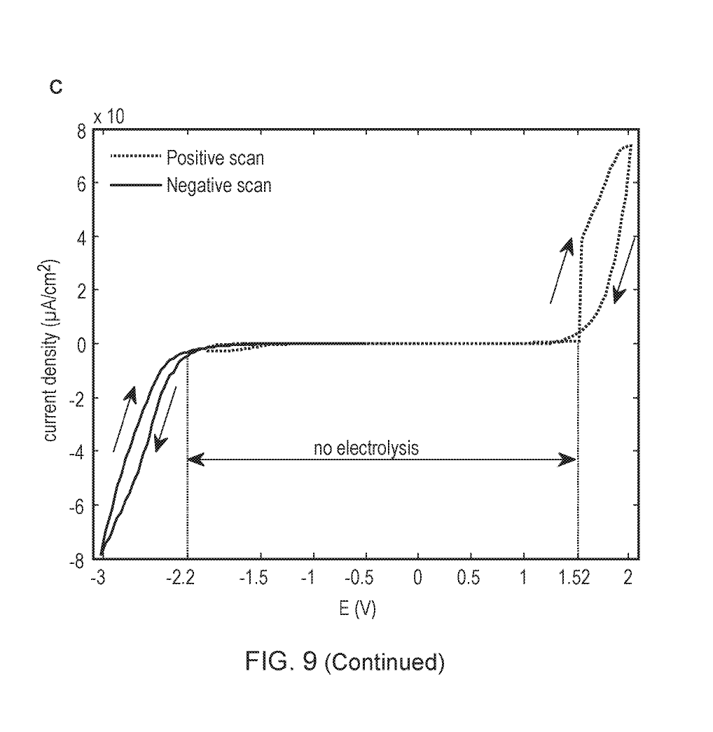

Once again, electrowetting occurred in the electrolysis window. FIG. 9 shows liquid|liquid electrowetting on HOPG within the electrolysis potential window. (a) shows the change in apparent contact angle θ−θ_{eq} with applied potential. Here, the experiments were performed on two droplets (presented in FIG. 1), which were used to investigate the negative potential range (red symbols) and the positive potential range (blue symbols), respectively. In both cases, the value of the potential was incremented in steps of −0.1 V (+OA V) from E_{pzc}=−0.5 V, respectively. Electrowetting occurs for both positive and negative applied potentials, and changes in contact angle of up to 100 degrees are observed within the potential window where electrolysis is not present, defined in c. For positive applied potentials, the apparent contact angle saturates within this window, whereas for negative applied potentials the apparent contact angle decreases monotonically over the entire range investigated. (b) shows the percentage change in the footprint diameter of the droplet with applied potential. (c) shows the current density as a function of applied potential recorded during the electrowetting experiments. There is a sharp increase in current density for E>+1.5 V and E<−2.2 V, which indicates the onset of electrolysis. However, electrolysis is not present for −2.2 V<E<+1.5 V.

Electrowetting is seen at both positive and negative potentials (with respect to the PZC, here −0.5 V vs the Pt RE), although a more complex potential dependence than the liquid/air case is seen with a significant range, −1.0 V<E<+0.5 V, where no change in contact angle is seen. Note the onset of wetting at positive and negative potentials does not correspond to the potentials where electrolytic breakdown occurs, again indicating that EWOC can be decoupled from the electrolysis process (see FIG. 4(c)).

Analysis of Results

The liquid/air data was analysed in terms of equation (1) by plotting the data of FIG. 4(a) against the electrowetting number, η (see FIG. 10(a)). Note that equation 1 is normally derived by integration of surface charge per unit area, Q/A, with respect to potential, i.e.:

$${\int }_{{γ}_{0}}^{γ} d {γ}_{S / L} = {\int }_{{E}_{pzc}}^{E} \frac{- Q}{A} dE$$

where γ₀ is the interfacial tension of the uncharged interface. Balancing the tensions of the three interfaces, with the assumption that the interfacial capacitance is independent of potential, leads directly to equation (1). The difficulties in measuring the capacitance with the EWOD configuration lead to such gross approximations, which are unrealistic for electrode/electrolyte interfaces, even over moderate excursions of potential. Instead a numerical integration of the capacitance is performed to evaluate η in FIG. 4 (solid line, FIG. 10(a)), where the potential-dependent capacitance, measured via AC impedance, is shown in FIG. 10(b). The graph illustrates good agreement with equation 1, although a slight fall-off in contact angle is revealed at higher potentials (η values). The relatively good agreement between the calculated and experimental data implies that the electrowetting phenomenon can be rationalised in terms of the capacitance of the electrical double-layer formed at the graphite/droplet interface. This, in turn, explains why EWOC can be achieved with much lower voltages than the current standard EWOD configuration: the thickness of the EWOC dielectric layer is typically on the order of few microns, whereas the electrical double layer at the high electrolyte concentrations used with the EWOC configuration reported here is on the order of 1 nm thick. Given that capacitance is inversely proportional to the thickness of the layer (dielectric or electrical double layer), then equation 1 implies that a 100-fold increase in potential (given the square dependence) is required for EWOD to compensate for the 10⁴-fold decrease in capacitance associated with the presence of the dielectric.

The liquid-air electrowetting was directly compared with the Young-Lippmann prediction for positive applied potentials (Sedev, 2011), as shown in FIG. 10. FIG. 10(a) shows cosine of the apparent contact angle for a 6M LiCl electrolyte solution (symbols) as a function of the electrowetting number:

η=1/γ_{LV}∫_{E}_{_{pzc}}^{E}CEdE

where E_{pzc}=−0.2 V. C is the capacitance, where the experimental values are shown in (b), and γ_{LV}=83.3±0.11 mN/m, the surface tension of the electrolyte measured using the pendant drop method. The solid line is the Young-Lippmann prediction, where the maximum of cos θ=1 corresponding to complete spreading. The experimental measurements are in good agreement with the theory for small values of η≤0.4. The apparent contact angle decreases less rapidly with η beyond this range, but does not saturate reaching values down to 10 degrees. (b) shows experimentally measured capacitance as a function of applied potential. The error bars denote the standard deviation of three data sets.

Other Electrolytes

Electrowetting was performed using the standard setup described herein, with a droplet of electrolyte solution injected onto HOPG using the micropipette technique. All other electrolyte experiments presented here were investigated with the liquid|air configuration.

For the low concentration electrolyte work (≤3 M), a humidity chamber was employed to minimise evaporation of the droplets; measurements were conducted with the HOPG placed within a glass cell containing DI water to provide the humid environment.

The applied potential was stepped from the equilibrium potential, i.e. where no wetting occurs, in 0.1 V increments in either the positive or negative direction. Each sequence of potentials studied represents a new droplet on a freshly cleaved HOPG surface.

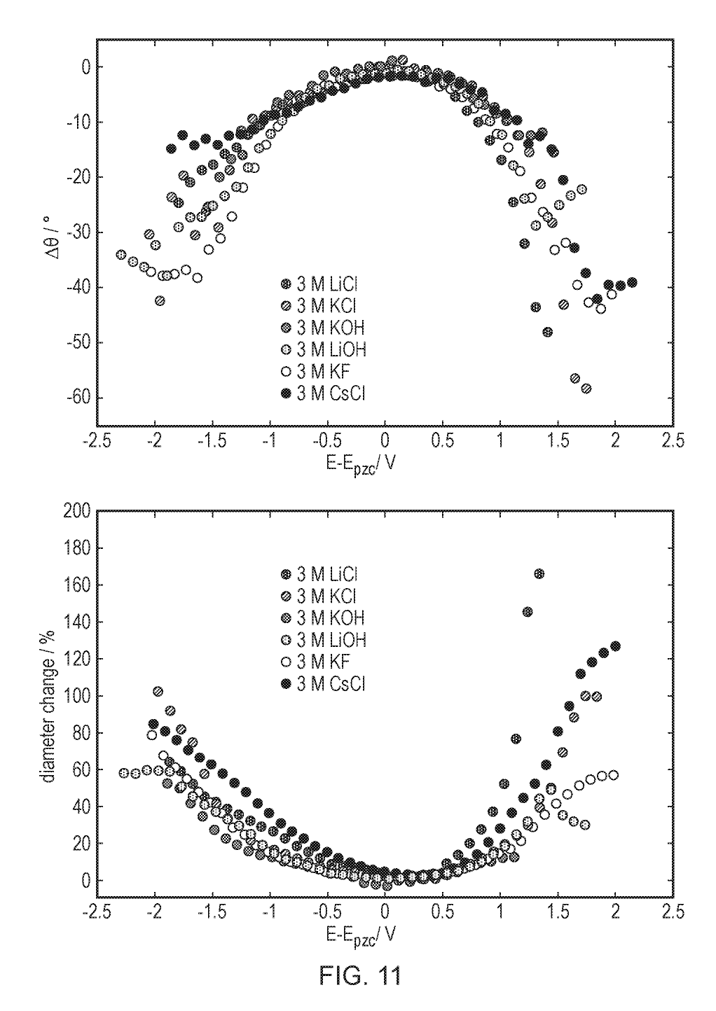

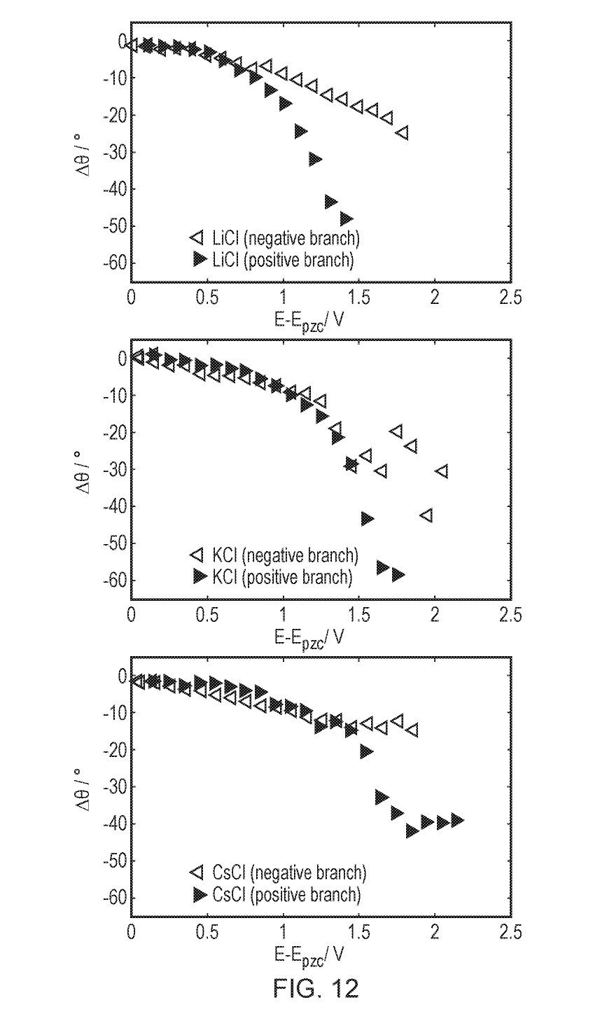

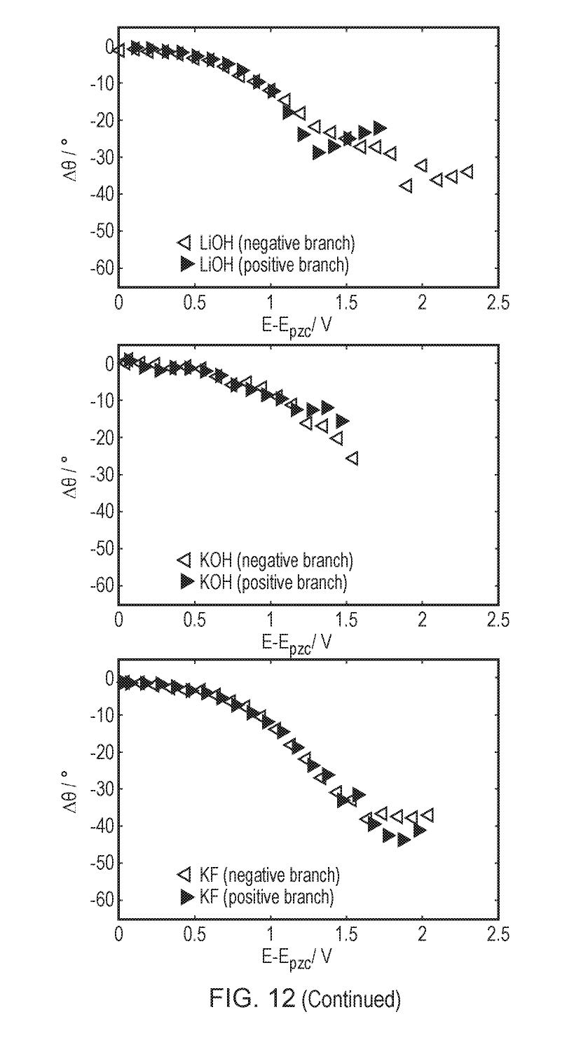

A range of 3 M electrolytes were used—LiCl, KCl, CsCl, LiOH, KOH and KF—with further KF solutions from 1 to 0.1 mM studied to show the effect of concentration on electrowetting. FIG. 11 shows the dependence of the change in contact angle and the change in drop diameter on the applied voltage for different inorganic salts. To account for the different potentials of zero charge (PZC), each curve is normalised so the point of maximum contact angle/minimum diameter lies at 0 V. The contact angle change is also presented in FIG. 12, with the positive and negative branches collapsed onto one curve to demonstrate the symmetry of each electrolyte.

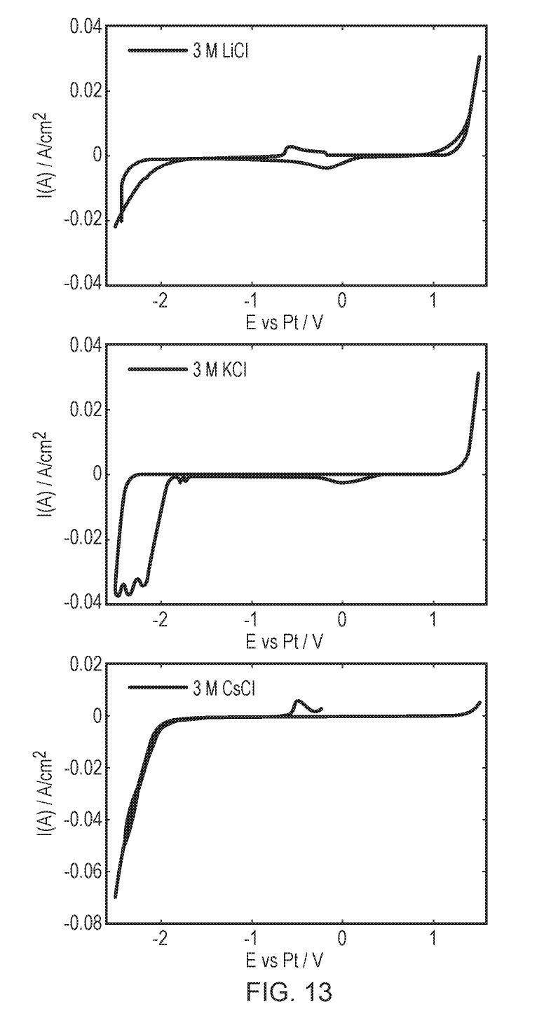

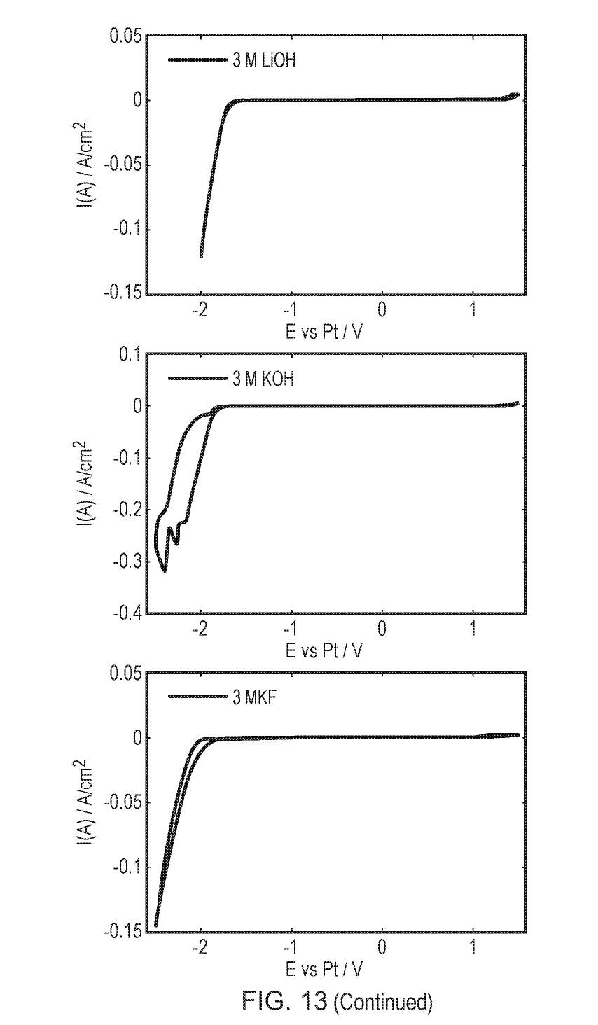

Cyclic voltammetry was also performed for each electrolyte, used to assess the range of potentials unaffected by electrolysis as electrolytic decomposition of the electrolyte/surface would likely impact reversibility. A Teflon cell was used to define a constant area of exposed HOPG (3 mm diameter). A Pt mesh counter electrode was used, with a Pt wire reference electrode. The results are shown in FIG. 13.

In addition to these aqueous solutions, two ionic liquids were used: 1-butyl-3-methylimidazolium tetrafluoroborate (BMIM BF₄) and 1-butyl-3-methylimidazolium hexafluorophosphate (BMIM PF₆).

Electro Wetting on Substrates Other than HOPG

It will be appreciated that use of HOPG in the above experiments is illustrative, and that other suitable conducting materials having the required properties may be used. For example, the inventors have observed electrowetting in similar devices according the present invention in which the substrate that serves as the working electrode is graphene (both exfoliated and CVD) or MoS₂. It will be appreciated that other conductive 2D materials and corresponding bulk 2D materials are suitable and devices and methods using these are within the scope of the invention. Similarly, the use of graphite is not limited to HOPG, other graphite structures are also envisaged.

### REFERENCES

The following publications are cited in this application. Each of these documents is incorporated by reference in its entirety for all purposes.
Kakade, B, R Mehta, A Durge, S Kulkarni, and V Pillai. 2008. “Electric Field Induced, Superhydrophobic to Superhydrophilic Switching in Multiwalled Carbon Nanotube Papers.” Nano Letters 8 (9) (September): 2693-2696.
Li, Z, Y Wang, A Kozbial, G Shenoy, F Zhou, R McGinley, P Ireland, et al. 2013. “Effect of Airborne Contaminants on the Wettability of Supported Graphene and Graphite.” Nature Materials 12 (10) (July 21): 925-931.
Mugele, F, and 3-C Baret. 2005. “Electrowetting: From Basics to Applications.” Journal of Physics: Condensed Matter 17 (28) (July 20): R705-R774.
Sedev, R. 2011. “Electrowetting: Electrocapillarity, Saturation, and Dynamics.” The European Physical Journal Special Topics 197 (1) (August 30): 307-319.
Sparnaay, M 3. 1964. “On the Electrostatic Contribution to the Interfacial Tension of Semiconductor/gas and Semiconductor/electrolyte Interfaces.” Surface Science 1: 213-224. http://www.sciencedirect.com/science/article/pii/0039602864900287.
Sondag-Huethorst, J A M, and L G J Fokkink. 1992. “Potential-Dependent Wetting of Octadecanethiol-Modified Polycrystalline Gold Electrodes.” Langmuir 8: 2560-2566.
Tan, X, Z Zhou, and M M-C Cheng. 2012. “Electrowetting on Dielectric Experiments Using Graphene.” Nanotechnology 23 (37) (September 21): 375501.
Vallet, M., B. Berge, and L. Vovelle. 1996. “Electrowetting of Water and Aqueous Solutions on Poly(ethylene Terephthalate) Insulating Films.” Polymer 37 (12) (June): 2465-2470. doi:10.1016/0032-3861(96)85360-2.

1. An electrowetting device comprising a cell, the cell comprising:
a working electrode that is formed of a laminar material having a working surface having a surface roughness R_{q} of 20 nm or less;
an electrolyte droplet provided on the working surface;
a counter electrode in electronic communication with the droplet;
configured such that, when a potential difference is applied between the working electrode and the counter electrode, the droplet undergoes a potential-induced change in surface tension;
wherein the working surface is provided free of a dielectric layer; and
wherein the laminar material is selected from graphite, graphene, MoS₂, MoSe₂, and WS₂.

2. The device of claim 1, wherein the electrolyte droplet is surrounded by a gaseous phase.

3. The device of claim 1, wherein the electrolyte droplet is surrounded by a surrounding liquid phase which is immiscible with the electrolyte droplet, optionally wherein the surrounding liquid phase is also an electrolyte.

4. An electrowetting device comprising a cell, the cell comprising:
a working electrode that is formed of a laminar material having a working surface having a surface roughness R_{q} of 20 nm or less, and
a droplet provided on the working surface and a surrounding liquid phase which is an electrolyte, the surrounding liquid phase being immiscible with the droplet;
and a counter electrode in electronic communication with the surrounding liquid phase, configured such that, when a potential difference is applied between the working electrode and the counter electrode, the droplet undergoes a potential-induced change in surface tension;
wherein the working surface is provided free of a dielectric layer; and
wherein the laminar material is selected from graphite, graphene, MoS₂, MoSe₂, and WS₂.

5. The device of claim 4, wherein the working surface of the cell is substantially free of defects of height greater than 100 nm, optionally greater than 50 nm, optionally greater 20 nm.

6. The device of claim 4, wherein the laminar material is cleaved graphite, graphene, or MoS₂.

7. The device of claim 4, wherein the laminar material is highly ordered pyrolytic graphite (HOPG).

8-11. (canceled)

12. The device of any of preceeding claim 4, wherein the droplet has a diameter of 10 μm to 1000 μm, or optionally a diameter of 100 μm to 300 μm.

13. (canceled)

14. The device of claim 1, wherein the electrolyte droplet is an aqueous salt solution; optionally wherein the concentration of the aqueous salt solution is greater than 0.1 M, optionally greater than 1 M, or optionally greater than 3 M.

15. The device of claim 1, wherein the electrolyte droplet is an aqueous chloride salt solution.

16-18. (canceled)

19. The device of claim 15, wherein the chloride salt is lithium chloride or magnesium chloride.

20. The device of claim 1, wherein the working surface of the cell is substantially free of defects of height greater than 100 nm, optionally greater than 50 nm, optionally greater 20 nm.

21. The device of claim 1, wherein the laminar material is cleaved graphite, graphene, or MoS₂.

22. The device of claim 1, wherein the laminar material is highly ordered pyrolytic graphite (HOPG).

23. The device of claim 1, wherein the electrolyte droplet has a diameter of 10 μm to 1000 μm, or optionally a diameter of 100 μm to 300 μm.
